(19) United States
(12) Patent Application Publication
(10) Pub. No.: US 2002/0166557 A1
(43) Pub. Date: Nov. 14, 2002

(54) Mask with a built-in microphone

(76) Inventor: David Cooper, Carlsbad, CA (US)

Correspondence Address: OPPENHEIMER WOLFF & DONNELLY, P. O. BOX 10356, PALO ALTO, CA, 94303, US

(21) Appl. No.: 10/143,246

(22) Filed: May 9, 2002

Related U.S. Application Data
(60) Provisional application No. 60/289,907, filed on May 9, 2001.

(51) Int. Cl. A62B 18/02; A42B 1/24

(52) U.S. Cl. 128/206.28; 2/422

(57) ABSTRACT

The present invention includes a face mask having a built-in microphone. The mask is for placement over the face of a user who is to give verbal instructions to control operations of an equipment. The mask is equipped with a microphone embedded therein. The microphone is preferably located in the center of the mask, aligned with the front of the mouth of the speaker. The microphone routes communications through a cable. The microphone is connected to a transmitter via the cable. The mask may be removed and disposed of following its use.

### CROSS-REFERENCE TO RELATED APPLICATIONS

Reference is made to and priority claimed from U.S. Provisional Application Serial No. 60/289,907, filed May 9, 2001, entitled “Disposable Mask With Microphone.”

### FIELD OF THE INVENTION

The present invention relates to a mask, and more particularly to a mask having a built-in microphone.

### BACKGROUND OF THE INVENTION

Over time, there has been a steady influx of electronic high tech equipment into various industries, especially in the medical instrument market. Such equipment, for instance, includes items such as video endoscopes, ultrasound, digital x-ray, etc. Generally, systems allowing for utilization of these types of equipment require some type of control mechanism. For example, control may be in the form of push buttons, a computer mouse, a light pen, a touch screen, etc. Some of the equipment includes a mechanism that allows control from a remote position.

The aforementioned remote control mechanisms, however, have certain disadvantages associated therewith. In medical applications, for example, infection control requires sterilization or some type of barrier protection. Often the barrier is in the form of a disposable plastic film. Accordingly, certain components providing the means for control may need to be covered with a protective barrier, resulting in added preparation time, lost sensitivity and resultant difficulty of use.

As another example, strict sterility regulations apply in surgical settings. Consequently, control devices cannot be located within the sterile field unless they are sterile or totally bagged to provide a sterile protective barrier. Further, most surgical procedures require free two hands, which precludes the operator (e.g. surgeon) from directly controlling the equipment with his or her hands.

Alternatively, such a scenario may require the presence of an additional equipment operator, who manually controls the system from an area outside the sterile field according to instructions from the surgeon performing the job.

This type of scenario creates increased expense due to sterilization and expense of communication devices or the training of a remote operator, salary of the remote operator, etc. Further, controlling critical equipment through a third party decreases efficiency and slows reaction time, which may be hazardous to the patient's health, or even life threatening. Thus, an improved method of communicating with, and thus controlling the operation of, the equipment is desirable. Otherwise, the operator must abandon a sterile environment or otherwise inconvenience him or herself in order to directly communicate with, and thereby control, the equipment. Such a consequence can be especially hazardous in a life threatening surgical situation.

Relying on third persons for the relay of information, such as instructions, etc., and control of the equipment can be disorganized, may result in lowered productivity, and can cause serious mistakes to be made due to miscommunication. Furthermore, relaying information through various parties or attempting to control equipment oneself may result in the unsafe use of medical instrumentation (and numerous other types of equipment), for example, in a situation where two-handed operation is required. Additionally, these scenarios create an unsafe environment generally, since they divert visual, manual, or mental attention.

Furthermore, in industrial applications, a hazardous environment may also require using both hands of the operator for safe operation of certain equipment. In some cases, such control may be achieved by a remote operator. In both medical and industrial applications, it may be desirable to provide continuous commentary, or reports. This scenario is also better achieved by freeing both hands to perform the procedure about which reports or comments are being made.

The aforementioned practices do not provide an effective means of control, particularly in medical applications, which requires hands-free capability, totally accurate equipment control with a minimum possibility of errors. Accordingly, there is a need in various industries for a communication system that conveniently allows for the manipulation of equipment within that particular industry.

### SUMMARY OF THE INVENTION

Accordingly, it is an object of the present invention to provide improved techniques for relaying information for the remote control of equipment operation systems in particular environments.

It is another object of the present invention to provide voice recognition, or control, from an optimally positioned microphone in a face mask.

It is yet another object of the present invention to provide a means that will maintain the microphone in a fixed position relative to the mouth of the speaker.

It is still a further object of the present invention to provide a cost effective disposable face mask and microphone combination for reliable voice recognition, or control.

Briefly, a presently preferred embodiment of the present invention includes a disposable mask having a built-in microphone. A mask is provided for placement over the face of a user who is to give verbal instructions to control operations of an equipment. The mask may be a sterile mask to be used in a surgical environment or a clean room, or a nonsterile mask to be used in an environment where no particular compliance is required, such as those utilized at construction sites or in arts and crafts environments. The mask is equipped with a microphone embedded therein. The microphone is preferably located in the center of the mask, aligned with the front of the mouth of the speaker. The microphone routes communications through a cable, which may also be sterile or non-sterile. The microphone is connected to a transmitter via the cable. The cable may be routed underneath clothing, such as a surgical gown. The transmitter may also be located under the clothing. Further, the transmitter may also be sterile or non-sterile. The mask and/or microphone may be removed and disposed of following its use.

An advantage of the present invention is that it enables a cost effective method of providing communication in a sterile environment.

These and other objects and advantages of the present invention will become clear to those skilled in the art upon review of the following specification, the accompanying drawings and the appended claims.

### BRIEF DESCRIPTION OF THE DRAWINGS

The invention will be better understood when consideration is given to the following detailed description thereof. Such description makes reference to the annexed drawings wherein:

FIG. 1 is a diagram illustrating a face mask with a microphone in place in accordance with an embodiment of the present invention;

FIG. 2 is a flowchart illustrating a process for utilizing a face mask with a microphone in place in accordance with an embodiment of the present invention;

FIG. 3 is a diagram depicting a remote control system in accordance with an embodiment of the present invention; and

FIGS. 4A-4F are diagrams showing various configurations for connecting the microphone to the transmitter.

### DETAILED DESCRIPTION OF THE PREFERRED EMBODIMENTS

An existing solution is a microphone placed in front of the user at a close distance thereto, utilizing a head mounted unit with the microphone on the end of a stick, such as is typically used by a telephone switch board operator. However, a major problem in the effective and reliable use of voice recognition, or control, is the position of the microphone. Typically, the voice recognition system is set up or trained with the microphone located in a fixed position relative to the user's mouth and a controlling means trained and adjusted for optimal performance with the audio signal components thereby produced. The voice signal from the microphone has different composition depending on its position relative to the user's mouth, which difference can result voice recognition errors. For reliable voice recognition results, especially in environments where safety is of the utmost concern, the microphone should be positioned in a fixed and repeatable location relative to the speaker's mouth. Although a headset, consisting of earphones and microphone, can be used in environments where safety is not as important, with the position of the microphone adjusted to be in the required location relative to the speaker's mouth, such an embodiment is not acceptable where increased safety is required. The position of the microphone might be inadvertently changed, for example, by a quick movement of the head or accidentally changing the microphone position relative to the mouth, causing commands, or commentary to be misheard or erroneously recognized by the voice recognition process. Such a scenario may result in potentially hazardous command errors. In surgical applications, a headset mounted microphone is not only dangerous, but is often impractical. Sterilization or barrier protection is required, however, bagging the instrument may also distort the voice signal, giving rise to recognition errors. Also, in many cases, the Surgeon may wear another head-mounted instrument, such as magnifying glasses, virtual imaging device, which would render a head-mounted microphone impractical.

Basically, for effective voice control or recognition, the microphone must be reliably placed in a fixed and repeatable position relative to the user's mouth, and it must be sterile, or provided with barrier protection in medical applications.

Sterilization by heat or soaking in a suitable biological agent is likely to have destructive results, and gas sterilizing is excessively time consuming. A microphone located in a disposable face mask provides an effective solution. The microphone will be maintained in a fixed position relative to the user's mouth and the mask provides the necessary barrier protection.

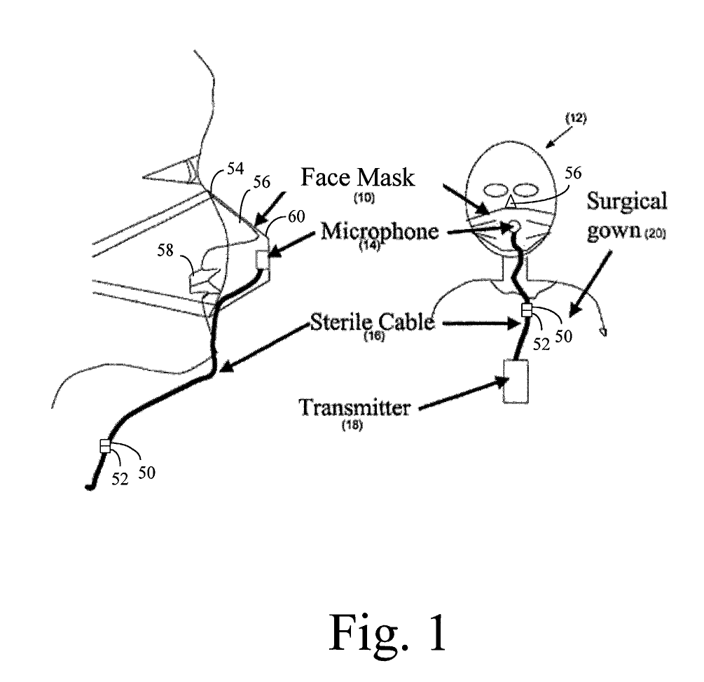

The present invention is a disposable mask with a microphone. An exemplary preferred embodiment of the present invention is illustrated in FIGS. 1, 2, 3 and 4A-4F.

FIG. 1 illustrates a face mask with a built-in microphone positioned in a location inside the mask for effective voice recognition in accordance with an embodiment of the present invention. A face mask 10 is provided for placement in the front of a user's face over the head of the user 12. The face mask could be a surgical mask to be used in an operating room. The face mask 10 is equipped with a microphone 14 embedded or otherwise installed therein. The microphone 14 routes communications through a sterile cable 16. The microphone 14 is connected to a transmitter 18 via the sterile cable 16. The sterile cable 16 may be routed underneath a surgical gown 20. The transmitter 18 may also be located under the surgical gown 20 to provide barrier protection.

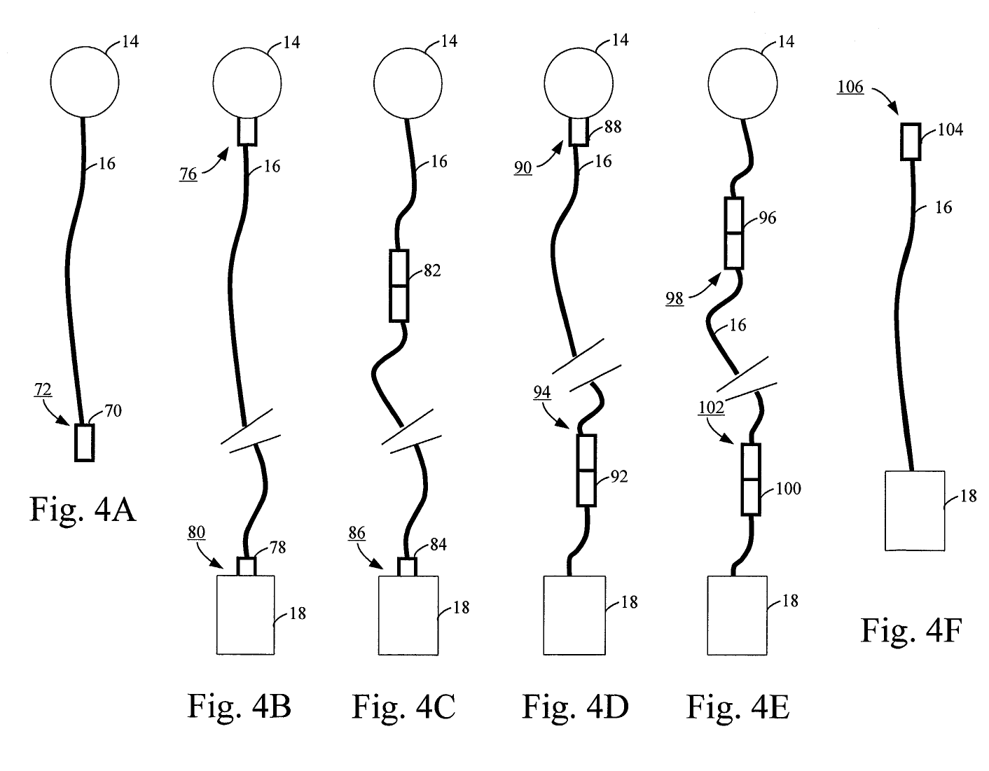

The sterile cable 16 connects the microphone to the transmitter. Various connecting means are shown in FIG. 4.

In FIG. 4A, the cable 16 is hard-wired into the microphone 14 and has a connector 70 at a distal end 72, which plugs into the transmitter (not shown).

In FIG. 4B, the cable 16 has a connector 74, which plugs into the microphone 14 at one end 76, and a connector 78, which plugs into the transmitter 18 at the other end 80.

In FIG. 4C, the cable 16 connects to a flying connector 82 from the microphone 14 and a connector 84 at the other end 86 plugs into the transmitter 18.

In FIG. 4D, the cable 16 has a connector 88, which plugs into the microphone 14 at one end 90 and connects to a flying connector 92 from the transmitter 18 at the other end 94.

In FIG. 4E, the cable 16 connects to a flying connector 96 from the microphone 14 at one end 98 and a flying connector 100 from the transmitter 18 at the other end 102.

In FIG. 4F, the cable 16 is hard-wired into the transmitter 18 and has a connector 104 at the distal end 106, which may plug into a microphone (not shown) or a flying connector (not shown) hard-wired to the microphone.

With the surgical mask 10 in place, the user 12 may speak into the microphone 14 embedded in the surgical mask 10. Preferably, the microphone 14 is mounted in the proximity of the center of the mask 10 for the most effective conveyance of voice signals. The mask 10 further has a bulging section 54 to fit over the nose 56 of the user's face. The bulging section 54 is provided to make sure that the mask 10 is fit over the user's face properly and it is important to orient and position the mask so that the microphone 14 is placed in a fixed and repeatable position relative to the user's mouth 58. Further, the bulging section secured over the user's nose prevents the mask from moving or shifting. As a result, the microphone will remain in a stationary position relative to the user's mouth. Ideally, the microphone 14 is to be positioned in a fixed and repeatable position relative to the user's mouth to receive the voice for reliable voice recognition results in controlling equipment having voice recognition capability. In the exemplary embodiment of the present invention, the microphone is installed in a position in the center below the bulging section 54 of the mask 10, which accommodates the user's nose, and below the tip 60 of the mask 10, where the tip of user's nose is anticipated. In an alternative embodiment, the mask 10 may have a bulging section or another means to receive the nose, such as a malleable strip, to ensure a close fit and a repeatable position over the user's nose.

The microphone 14 is preferably a low cost microphone, such as those integrated into cellular telephones. Such a low cost microphone better allows for the disposability of the mask with microphone. The transmitter 18 may be a reusable transmitter. Since the mask 10 can be severed from the transmitter 18 by disconnecting the connectors 50 and 52 on the cable 16, the mask 10 and/or microphone 14 can be disposed after usage without disposing the transmitter 18.

Alternatively, the microphone may clip into the mask in the required location and can be detached prior to disposing of the mask alone.

The face mask causes the microphone to be positioned within the proximity of the user's mouth, which is necessary for reliable voice recognition and control. This is especially important in medical applications and certain industrial applications, where voice communication errors can create a safety hazard or even be life threatening.

The face mask 10 may be sterile or non-sterile to be used in surgical environment. The mask of the present invention may be practiced with a mask of non-surgical use as well. For example, a sterile mask may be utilized in any clean room or alternate sterile environment. Where sterility is required, the sterile cable 16 and transmitter 18 may be routed beneath the sterile clothing. In addition, the cable 16 and transmitter 18 may be routed outside the clothing with the cable 16 and transmitter 18 being guarded by a protective barrier of some sort or sterilized themselves. Furthermore, a non-sterile mask may be used in any non-sterile environment, such as at a construction site for allowing communication while preventing the inhalation of dust, paint, chemicals, etc. Similarly, in a non-sterile environment, a non sterile cable and transmitter may be routed beneath or outside the clothing.

The microphone 14 may be any type of microphone capable of being mounted in a mask and allowing for the disposability thereof. In one embodiment of the present invention, a reusable microphone may be positioned in the inside of a disposable mask, which mask is designed to hold and correctly position the microscope. In this embodiment, the microphone may itself be sterilized prior to insertion into the sterile, disposable mask. Otherwise, the non-sterilized microphone may be placed in the disposable mask so as not to violate the sterile regulations of the mask, such as when the inside of the mask is handled in a non-sterile fashion, but the outside of the mask remains sterile. Further, where a non-sterile disposable mask is not provided, the microphone and mask may both be sterilized by separate sterilization procedures, or together as one device. In addition, sterilization may not be required, in which case the disposable mask and microphone need not be sterilized.

A porous, light weight face mask may be used, which provides the necessary filtering action, allows the sound of the wearer's voice to pass through the material, allows normal breathing, and is comfortable and cool. Such masks are not recommended for reuse in medical applications and many industrial uses, hence they are disposable. Such a mask is ideal for installing a microphone therein. Due to the current high production volume of microphones, which is driven by the cellular phone market, these are of sufficiently low cost to permit a disposable mask with a microphone. However, non-porous masks may also be used in the present invention, as long as they provide means for normal breathing.

In an alternative embodiment, the transmitter may be installed in the mask with the microphone to eliminate the cable. The mask having the embedded transmitter and microphone may serve as barrier protection, permitting the use of a non-sterile microphone and transmitter.

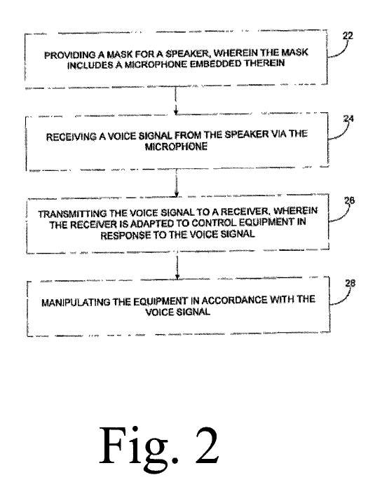

FIG. 2 is a flowchart illustrating a process for utilizing a disposable mask with a microphone in place in accordance with an embodiment of the present invention. In operation 22, a speaker places a mask on the head area, covering the mouth. The speaker speaks into the microphone embedded in the mask in operation 24. In operation 26, the voice signal is transmitted for remotely controlling the equipment under the speaker's direction. The equipment is manipulated, according to the voice signal, in operation 28.

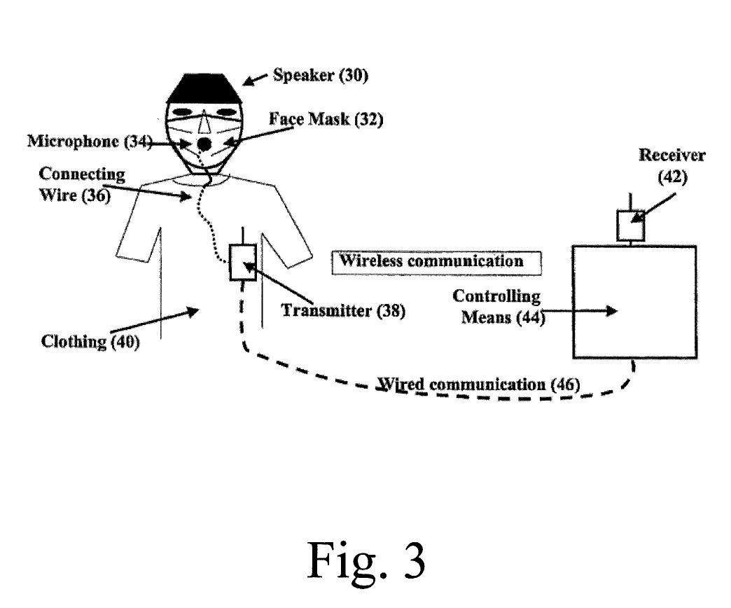

FIG. 3 illustrates wireless communication in accordance with an embodiment of the present invention. A user 30 wearing a face mask 32 having a microphone 34 installed in the face mask 32. A connecting wire 36 couples the microphone 34 to a transmitter 38. Depending on the sterility of the field, the connecting wire 36 and transmitter 38 can be routed above or underneath clothing 40 of the user 30. The communications of the user 30 are transmitted by the transmitter 38 and received by a receiver 42 coupled to a controlling means 44 via wireless communication. Alternatively, the microphone 34 may be connected to the receiver 42 via wired communication 46.

The control means 44 acts upon commands from the user 30. Upon receipt of the commands or instructions, the control means 44 effects the user's desired manipulation of the equipment sought to be controlled. In the present invention, the control means includes a voice recognition mechanism that respond to the user's verbiage commands or instructions to manipulate the operation of the equipment in accordance with such commands or instructions. Due to the central placement, and stabilization, of the microphone, the commands or instructions are especially clear. Such verbal commands or instructions may be correctly recognized. Accordingly, the equipment may easily be controlled, with little or no communication difficulties.

In a preferred embodiment of the present invention, the voice signal is transmitted to the equipment directly. Thus, the equipment is manipulated in response to the voice signal. In other words, the equipment is voice activated. In an alternative embodiment of the present invention, the voice signal is transmitted to a remote operator, who manually manipulates the equipment in response thereto.

A feedback mechanism may facilitate direct communication between the mask user and the equipment controller. For example, the mask user may wear an ear piece of some type that receives signals affirming instructions or requests, or indicates that there are further inquiries in order to clarify the instructions of the mask user. The feedback can also be visual. For instance, such feedback may include a monitor placed in a sterile field, outside of the sterile field but viewable therefrom, or in a non-sterile field. The speaker may receive visual cues that affirm instructions, visual cues that request further instructions, visual cues indicating that the voice signal was not clearly received, etc. The visual or audio cues may be received from the equipment system directly, or from a remote operator of the equipment. Feedback may also be communicated from a mask user through audio broadcast audible by the mask user.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A mask that fits over a user's mouth and nose, comprising:
a positioning section suitable for fitting over the user's nose;
a microphone embedded in the mask positioned in the proximity of the user's mouth; and
an electric cable coupled to the microphone and further coupled to a transmitter to transmit verbiage of the user.

2. A mask as recited in claim 1, wherein the transmitter is to transmit the verbiage to a receiver that controls the operation of an equipment.

3. A mask as recited in claim 1, wherein the microphone is installed inside the mask.

4. A mask as recited in claim 1, wherein the mask is a surgical mask.

5. A mask as recited in claim 1, wherein said microphone is installed in a predetermined location within the mask.

6. A mask as recited in claim 1, wherein said microphone is installed in a predetermined location within the positioning section of the mask.

7. A mask as recited in claim 1, wherein said positioning section including a malleable strip.

8. A mask as recited in claim 1, wherein said positioning section is bulging in shape.

9. A mask as recited in claim 8, wherein the bulging section of the mask further having a tip and said microphone is installed below the tip.

10. A mask as recited in claim 1, wherein said mask is a porous face mask.

11. A mask as recited in claim 1, wherein said cable is hard-wired to the microphone having a connector coupled to the transmitter, wherein through the connector the transmitter can be disconnected from the mask.

12. A mask as recited in claim 1, wherein said cable is hard-wired to the transmitter having a connector for connecting to the microphone, wherein through the connector the transmitter can be disconnected from the mask.

13. A mask as recited in claim 1, wherein said cable includes a flying connector that couples the transmitter to the microphone.

14. A control system, comprising:
a face mask that fits over a user's mouth and nose for controlling operations of an equipment, including:
a positioning section that is suitable for fitting over the user's nose; and
a microphone embedded in the mask positioned in the proximity of the user's mouth for accepting signals of verbiage instructions of the user; and
a control means coupled to said microphone for controlling operations of the equipment in accordance with said verbiage instruction signals.

15. A control system as recited in claim 14, wherein the microphone is installed inside the face mask.

16. A control system as recited in claim 14, wherein the mask is a surgical mask.

17. A control system as recited in claim 14, wherein said microphone is installed in a predetermined location within the mask.

18. A control system as recited in claim 14, wherein said microphone is installed in a predetermined location within the positioning section of the mask.

19. A control system as recited in claim 14, wherein said positioning section including a malleable strip.

20. A control system as recited in claim 14, wherein said positioning section is bulging in shape.

21. A control system as recited in claim 20, wherein the bulging section of the mask further having a tip and said microphone is installed below the tip.

22. A remote control system, comprising:
a face mask that fits over a user's mouth and nose for controlling operations of a remote equipment, including:
a positioning section that is suitable for fitting over the user's nose;
a microphone embedded in the mask positioned in the proximity of the user's mouth; and
an electric cable coupled to the transmitter and further coupled to a transmitter for transmitting signals of said verbiage instructions of the user; and
a control means coupled to said microphone for controlling operations of the remote equipment in accordance with said verbiage instruction signals.

23. A remote control system as recited in claim 22, wherein said control means is coupled to said transmitter via wireless communication.

24. A remote control system as recited in claim 23, wherein said control means is coupled to a receiver for receiving signals transmitted from the transmitter.

25. A remote control system as recited in claim 22, wherein the microphone is installed inside the face mask.

26. A remote control system as recited in claim 22, wherein the mask is a surgical mask.

27. A remote control system as recited in claim 22, wherein said microphone is installed in a predetermined location within the mask.

28. A remote control system as recited in claim 22, wherein said microphone is installed in a predetermined location within the positioning section of the mask.

29. A remote control system as recited in claim 22, wherein said positioning section including a malleable strip.

30. A remote control system as recited in claim 22, wherein said positioning section is bulging in shape.

31. A remote control system as recited in claim 30, wherein the bulging section of the mask further having a tip and said microphone is installed below the tip.

32. A remote control system as recited in claim 22, wherein said cable is hard-wired to the microphone having a connector coupled to the transmitter, wherein through the connector the transmitter can be disconnected from the mask.

33. A remote control system as recited in claim 22, wherein said cable is hard-wired to the transmitter having a connector for connecting to the microphone, wherein through the connector the transmitter can be disconnected from the mask.

34. A remote control system as recited in claim 22, wherein said cable includes a flying connector that couples the transmitter to the microphone.
